(19) United States
(12) Patent Application Publication
(10) Pub. No.: US 2024/0064714 A1
(43) Pub. Date: Feb. 22, 2024

(54) TWO-DIMENSIONAL RESOURCE ALLOCATION

(71) Applicant: Samsung Electronics Co., Ltd., Gyeonggi-do (KR)

(72) Inventors: Srinivas KANDALA, Morgan Hill, CA (US); Wook Bong LEE, San Jose, CA (US); Ruchen DUAN, Santa Clara, CA (US); Vamadevan NAMBOODIRI, San Jose, CA (US); Mark RISON, Cambridge (GB)

(21) Appl. No.: 18/364,083

(22) Filed: Aug. 2, 2023

Related U.S. Application Data
(60) Provisional application No. 63/398,994, filed on Aug. 18, 2022.

(51) Int. Cl. H04W 72/0446; H04W 72/0453

(52) U.S. Cl. CPC H04W 72/0446; H04W 72/0453

(57) ABSTRACT

Methods and apparatuses are provided in which an access point (AP) transmits a trigger frame to one or more user equipments (UEs). The trigger frame includes an indication of allocated resource units (RUs) for random access (RA). A UE allocates respective data to a sets of RUs for RA that are consecutive in a single frequency segment over a time domain of a physical protocol data unit (PPDU), based on the trigger frame. The UE transmits the PPDU to the AP.

### CROSS-REFERENCE TO RELATED APPLICATION

This application claims the priority benefit under 35 U.S.C. § 119(e) of U.S. Provisional Application No. 63/398,994, filed on Aug. 18, 2022, the disclosure of which is incorporated by reference in its entirety as if fully set forth herein.

### TECHNICAL FIELD

The disclosure generally relates to an uplink (UL) orthogonal frequency-division multiple access (OFDMA) resource unit (RU) allocation. More particularly, the subject matter disclosed herein relates to a two-dimensional (2D) random access (RA) RU (RA-RU) in a physical (PHY) protocol data unit (PPDU).

### SUMMARY

For UL transmissions in OFDMA, an access point (AP) may assign RUs in the form of subcarriers to stations (STAs), which are also referred to as user equipments (UEs) herein. Upon receiving a trigger frame from the AP, the STAs may transmit their data through a trigger based (TB)-PPDU. Accordingly, an UL multi-user (MU) operation allows an AP to solicit simultaneous immediate response frames from one or more non-AP STAs.

The RU allocation is performed by the AP based on requests from the STAs that indicate an availability of data and a buffer size to be transmitted. There may be occasions where the AP does not allocate RUs to a specific STA. However, this specific STA may then not have an opportunity to transmit its data.

To solve this problem, the concept of RA-RU and the protocol, UL OFDMA-based RA (UORA), has been introduced for a STA that does not have any RUs assigned for transmission.

With respect to UORA, an AP may transmit a basic trigger frame, a bandwidth query report poll (BQRP) trigger frame, or a buffer status report poll (BSRP) trigger frame that contains one or more RUs for RA. An AP that transmits a trigger frame, other than the basic trigger frame, does not set an ‘AID12’ subfield (an association identifier (AID) subfield) of a ‘user info’ field of the frame, thereby indicating allocation of one or more RA-RUs for unassociated STAs. Further, an AP that transmits a trigger frame, other than the basic trigger frame, the BQRP trigger frame, and the BSRP trigger frame, does not set the ‘AID12’ subfield of the ‘user info’ field of the frame, thereby indicating allocation of one or more RA-RUs for associated STAs.

An AP may allocate a contiguous set of RUs for RA by setting a ‘number of RA-RUs’ subfield in the ‘user info’ field of the trigger frame to a value greater than 1. The RA-RU indicated by an ‘RU allocation’ subfield in the ‘user info’ field represents the starting RU of the set. The size of all RA-RUs in the set is the same as the size of the RA-RU indicated by the ‘RU allocation’ subfield in the ‘user info’ field. The remaining subfields of the ‘user info’ field apply to each RA-RU in the set. An AP allocating a contiguous set of RA-RUs in a trigger frame with an UL bandwidth (BW) subfield that indicates 80+80 MHz or 160 MHz sets the ‘number of RA-RUs’ subfield such that all RA-RUs in the set are within a single 80 MHz frequency segment.

One issue with the above approach is that an AP can only assign a resource in a frequency domain. Additionally, if the AP does not know that the non-AP STA has data to send, and if it is a time sensitive packet that arrives after the TB-PPDU has started, then the non-AP STA must wait for a next opportunity.

To overcome these issues, systems and methods are described herein for a new paradigm of latency-sensitive packet transmission relative to on-going TB-PPDU operations. For example, initiation of the transmission of a latency-sensitive packet during the pendency of on-going TB-PPDU operations in order to reduce latency is discussed, which is highly useful for RA.

The above approach improves on previous methods because it enables transmission of a latency-sensitive packet in the UL direction during a TB transmission, within a short duration of its arrival, and without waiting for the completion of an on-going TB transmission, which could be as long as 5 ms. A newly arrived packet is inserted into an on-going TB transmission when the AP is using UORA protocol and assigns resources to RA. Accordingly, the approach requires RA functionality, which may increase the channel efficiency.

In an embodiment, a method includes transmitting, from an AP, a trigger frame to one or more UEs. The trigger frame includes an indication of allocated RUs for RA. The AP receives a PPDU from the one or more stations based on the trigger frame. The PPDU includes respective data in sets of RUs for RA that are consecutive in a single frequency segment over a time domain of the PPDU.

In an embodiment, a method includes receiving, at a UE, a trigger frame from an AP. The trigger frame includes an indication of allocated RUs for RA. The UE allocates respective data to sets of RUs for RA that are consecutive in a single frequency segment over a time domain of a PPDU, based on the trigger frame. The UE transmits the PPDU to the AP.

In an embodiment, a UE includes a processor and a non-transitory computer readable storage medium storing instructions. When executed, the instructions cause the processor to receive a trigger frame from an AP. The trigger frame includes an indication of allocated RUs for RA. The instructions also cause the processor to allocate respective data to sets of RUs for RA that are consecutive in a single frequency segment over a time domain of a PPDU, based on the trigger frame, and transmit the PPDU to the AP.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating a communication system, according to an embodiment;

FIG. 2 is a diagram illustrating a 2D RU TB-PPDU, according to an embodiment;

FIG. 3 is a diagram illustrating a second set of RA-RUs of a 2D RU TB-PPDU, according to an embodiment;

FIG. 4 is a flowchart illustrating a method for performing 2D resource allocation at an AP, according to an embodiment;

FIG. 5 is a flowchart illustrating a method for performing 2D resource allocation at a UE, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

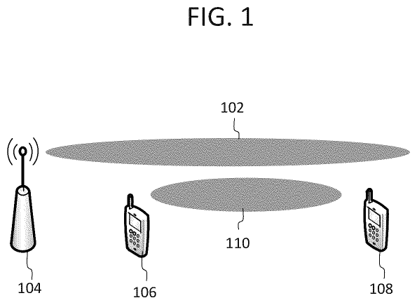

FIG. 1 is a diagram illustrating a communication system, according to an embodiment. In the architecture illustrated in FIG. 1, a control path 102 may enable the transmission of control information through a network established between a base station, AP, or a gNB 104, a first STA or UE 106, and a second STA or UE 108. A data path 110 may enable the transmission of data (and some control information) on a sidelink between the first STA 106 and the second STA 108. The control path 102 and the data path 110 may be on the same frequency or may be on different frequencies.

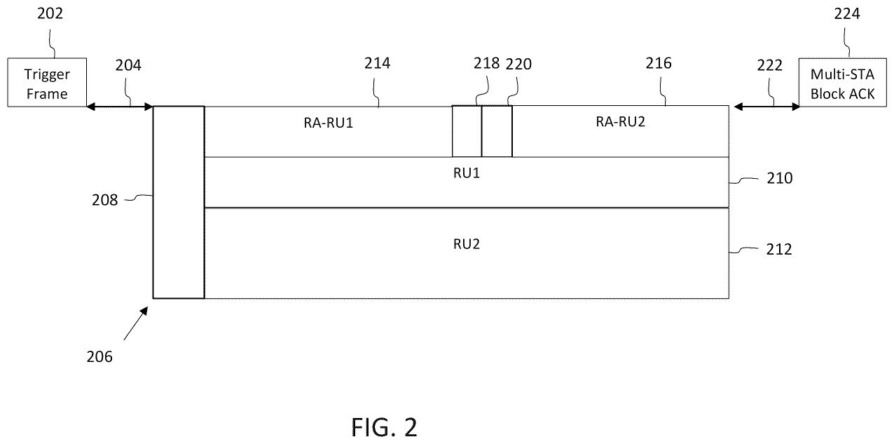

FIG. 2 is a diagram illustrating a 2D RU TB-PPDU, according to an embodiment of the disclosure. An AP transmits a trigger frame 202 to the STAs that contains RUs for RA, similar to that described above for the UORA protocol. Components of the trigger frame is described in greater detail below. After a first short interframe space (SIFS) 204, the STAs transmit data to the AP via a TB-PPDU 206. The TB-PPDU 206 includes a preamble 208. After the preamble 208, the TB PPDU 206 includes data allocated to RUs. Specifically, the TB-PPDU 206 includes a first RU (e.g., RU1) 210 for a first non-AP STA, and a second RU (e.g., RU2) 212 for a second non-AP STA. The data of the first non-AP STA and the second non-AP STA were known by the AP, and RU1 210 and RU2 212 were allocated by the AP with the purpose of carrying that data.

Additionally, after the preamble 208, the TB-PPDU 206 includes a first set of RA-RUs (e.g., RA-RU1) 214 having data, which the AP was not previously aware of, from a non-AP STA. Further, after the RA-RU1 214, a second set of RA-RUs (e.g., RA-RU 2) 216 are provided for a non-AP STA having time-sensitive data that the AP was not aware of and that arrived after the TB PPDU 206 began. Therefore, this time-sensitive data is able to be provided in the TB PPDU 206 instead of having to wait for a next opportunity. The RA-RU1 214 and the RA-RU2 216 are consecutive in the same single frequency segment of the TB-PPDU 206. The RA-RU1 214 and the RA-RU2 216 are separated only by a short training field (STF) 218 and a long training field (LTF) 220 in the single frequency segment. The allocation of both the RA-RU1 214 and the RA-RU2 216 is indicated by the trigger frame 202, as described in greater detail below. After the AP receives the TB-PPDU 206, and after a second SIFS 222, the AP transmits a multi-STA block acknowledgement (ACK) 224.

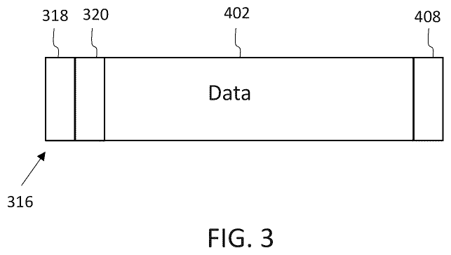

FIG. 3 is a diagram illustrating a second set of RA-RUs of a 2D RU TB-PPDU, according to an embodiment. Unlike the start/first position after the trigger frame and SIFS, a set of RA-RUs that begins later in the TB-PPDU does not require, for example, a legacy-STF (L-STF), a legacy-LTF (L-LTF), a legacy-signal field (L-SIG), a repeated L-SIG (RL-SIG), a high efficiency signal A field (HE-SIG-A), and a universal signal field (U-SIG). These fields are for other STAs that may hear the PPDU so that they may defer transmission.

Instead, the second set of RA-RUs (e.g., RA-RU 316) begins at an extremely-high throughput (EHT) (or ultra-high reliability (UHR)) STF 318 and LTF 320. A symbol duration for the STF 318 may be the same as other data symbols. Data 326 of the RA-RU2 316 follows the LTF 304, and the data 326 may be followed by a packet extension (PE) 328.

With respect to the trigger frame, the RA-RU information in the ‘user info’ field typically indicates the number of contiguous RA-RUs allocated for UORA and more RA-RU information. For UORA, the ‘RU allocation’ subfield in the ‘user info’ field typically represents the starting RU of the set.

A 2D RU TB-PPDU may be indicated by the trigger frame in several different ways. As a first indication option, a number of sets of RA-RUs in a time domain may be indicated in a ‘common info’ field of the trigger frame. As a second indication option, a number of sets of RA-RUs in the time domain and frequency domain may be indicated in the ‘RA-RU information’ subfield of the ‘user info’ field of the trigger frame. For example, the first one or two most significant bits (MSBs) may indicate a number of sets of RA-RUs in the time domain, while the other bits may indicate a number of contiguous RA-RUs (frequency domain) allocated for UORA. As a third option, reserved bits or other bits of the ‘user info’ field of the trigger frame may be used to indicate a number of sets of RA-RUs in the time domain.

With respect to the number of OFDM symbols for the 2D RU TB-PPDU, the time domain resource may be divided by the number of sets of RA-RUs in the time domain. For example, if the number of data OFDM symbols is N_{SYM} and the number of sets of RUs is K, then floor((N_{SYM}−(H*(K−1)))/K), where H is the number of non-data for each later RA-RU. As described above, H=2 when the number of LTF is 1 and the number of STF is 1.

When there are multiple sets of RA-RUs in the time domain, only the last set of RA-RUs in the time domain may be appended with the PE and the remaining unused symbols, which is N_{SYM}−K*floor((N_{SYM}−(H*(K−1)))/K). In this case, unused symbols can be modulated the same as the PE.

Alternatively, a first set of RA-RUs in the time domain may include N_{SYM}−K*floor((N_{SYM}−(H*(K−1)))/K) more symbols than later sets of RA-RUs in the time domain.

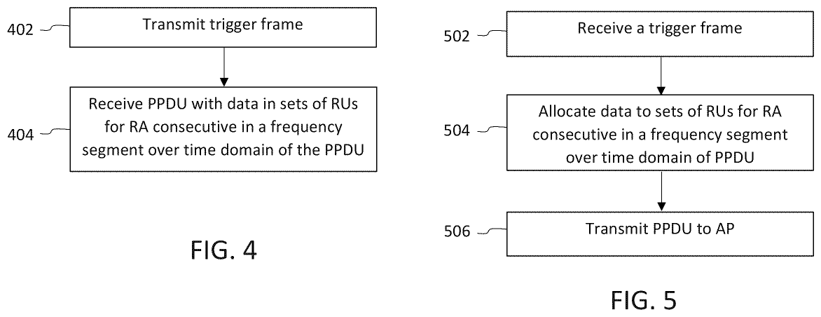

FIG. 4 is a flowchart illustrating a method for performing 2D resource allocation at an AP, according to an embodiment. At 402 a trigger frame is transmitted from the AP to one or more STAs/UEs. The trigger frame includes an indication of allocated RUs for RA. The trigger frame may include a common information field or bits indicating a number of sets of RUs for RA over a time domain of a PPDU. Alternatively, the trigger frame may include RA-RU information indicating a number of sets of RUs for RA in the time domain and a frequency domain of the PPDU. The RA-RU information includes one or two MSBs indicating a first number of the sets of RUs for RA over the time domain, and remaining bits indicating a second number of contiguous RUs for RA in a frequency domain of the PPDU.

At 404, the AP receives the PPDU from the one or more STAs, based on the trigger frame. The PPDU includes respective data in sets of RUs for RA that are consecutive in a single frequency segments over a time domain of the PPDU. Data in a non-initial set of RUs of the sets of RUs for RA may be latency-sensitive data from a respective station that is received at the respective station after a start of the PPDU.

A non-initial set of RUs of the sets of RUs for RA may be separated from preceding data only by an STF and an LTF. A number of OFDM symbols for each of the sets of RUs for RA may be determined based on a length of the time domain of the PPDU and a number STFs and LTFs for a non-initial set of RUs of the sets of RUs for RA in the time domain. An initial set of RUs or a last set of RUs of the sets of RUs for RA in the time domain may include more OFDM symbols than remaining sets of RUs of the sets of RUs for RA.

FIG. 5 is a flowchart illustrating a method for performing 2D resource allocation at a UE, according to an embodiment. At 502, a UE receives a trigger frame from an AP. The trigger frame includes an indication of allocated RUs for RA. At 504, the UE allocates respective data to sets of RUs for RA that are consecutive in a single frequency segment over a time domain of a PPDU, based on the trigger frame. At 506, the UE transmits the PPDU to the AP.

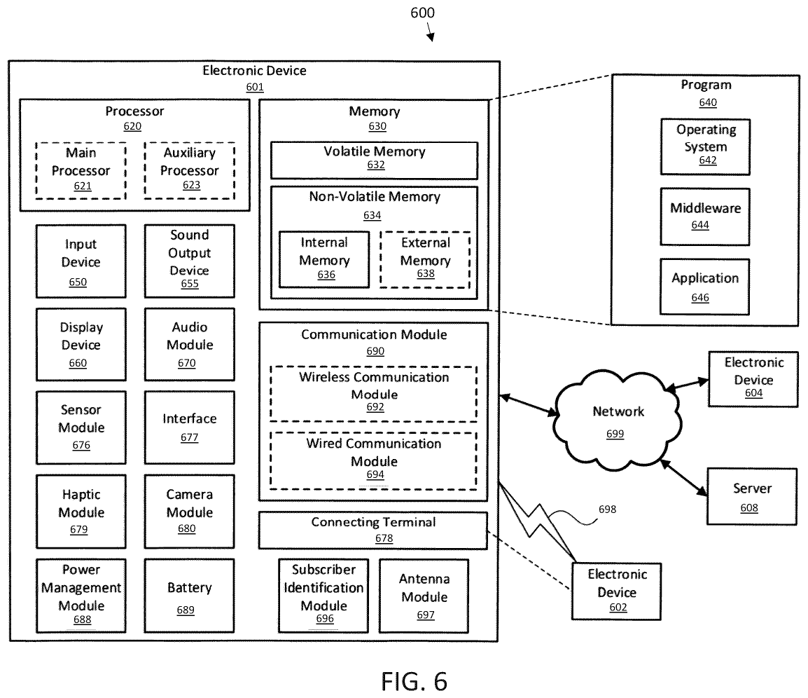

FIG. 6 is a block diagram of an electronic device in a network environment, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic devices 601, 602, and 604 may be embodied as a STA or UE, as described above with respect to FIGS. 1-5. The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
transmitting, from an access point (AP), a trigger frame to one or more user equipments (UEs), wherein the trigger frame comprises an indication of allocated resource units (RUs) for random access (RA);
receiving, at the AP, a physical protocol data unit (PPDU) from the one or more UEs, based on the trigger frame,
wherein the PPDU comprises respective data in sets of RUs for RA that are consecutive in a single frequency segment over a time domain of the PPDU.

2. The method of claim 1, wherein data in a non-initial set of RUs of the sets of RUs for RA is latency-sensitive data from a respective UE that is received at the respective UE after a start of the PPDU.

3. The method of claim 1, wherein the trigger frame comprises:
a common information field or bits indicating a number of the sets of RUs for RA over the time domain; or
RA-RU information indicating a number of the sets of RUs for RA in the time domain and a frequency domain of the PPDU.

4. The method of claim 3, wherein the RA-RU information comprises one or two most significant bits (MSBs) indicating a first number of the sets of RUs for RA over the time domain, and remaining bits indicating a second number of contiguous RUs for RA in a frequency domain of the PPDU.

5. The method of claim 1, wherein a non-initial set of RUs of the sets of RUs for RA is separated from preceding data by a short training field (STF) and a long training field (LTF).

6. The method of claim 1, wherein a number of orthogonal frequency division multiplexing (OFDM) symbols for each set of RUs for RA is determined based on a length of the time domain of the PPDU and a number of STFs and LTFs for a non-initial set of RUs of the sets of RUs for RA.

7. The method of claim 1, wherein an initial set of RUs or a last set of RUs of the sets of RUs for RA in the time domain comprises more OFDM symbols than remaining sets of RUs of the sets of RUs for RA.

8. A method comprising:
receiving, at a user equipment (UE), a trigger frame from an access point (AP), wherein the trigger frame comprises an indication of allocated resource units (RUs) for random access (RA);
allocating, by the UE, respective data to sets of RUs for RA that are consecutive in a single frequency segment over a time domain of a physical protocol data unit (PPDU), based on the trigger frame; and
transmitting the PPDU from the UE to the AP.

9. The method of claim 8, wherein data in a non-initial set of RUs of the sets of RUs for RA is latency-sensitive data received at the UE after a start of the PPDU.

10. The method of claim 8, wherein the trigger frame comprises:
a common information field or bits indicating a number of the sets of RUs for RA over the time domain; or
RA-RU information indicating a number of the sets of RUs for RA in the time domain and a frequency domain the PPDU.

11. The method of claim 10, wherein the RA-RU information comprises one or two most significant bits (MSBs) indicating a first number of the sets of RUs for RA over the time domain, and remaining bits indicating a second number of contiguous RUs for RA in a frequency domain of the PPDU.

12. The method of claim 8, wherein a non-initial set of RUs of the sets of RUs for RA is separated from preceding data by a short training field (STF) and a long training field (LTF).

13. The method of claim 8, wherein a number of orthogonal frequency division multiplexing (OFDM) symbols for each set of RUs for RA is determined based on a length of the time domain of the PPDU and a number of STFs and LTFs for a non-initial set of RUs of the sets of RUs for RA.

14. The method of claim 8, wherein an initial set of RUs or a last set of RUs of the sets of RUs for RA in the time domain comprises more OFDM symbols than remaining sets of RUs of the sets of RUs for RA.

15. A user equipment (UE) comprising:
a processor; and
a non-transitory computer readable storage medium storing instructions that, when executed, cause the processor to:
receive a trigger frame, from an access point (AP), wherein the trigger frame comprises an indication of allocated resource units (RUs) for random access (RA);
allocate respective data to sets of RUs for RA that are consecutive in a single frequency segment over a time domain of a physical protocol data unit (PPDU), based on the trigger frame; and
transmit the PPDU to the AP.

16. The UE of claim 15, wherein data in a non-initial set of RUs of the sets of RUs for RA is latency-sensitive data received at the UE after a start of the PPDU.

17. The UE of claim 15, wherein the trigger frame comprises:
a common information field or bits indicating a number of the sets of RUs for RA over the time domain; or
RA-RU information indicating a number of the sets of RUs for RA in the time domain and a frequency domain the PPDU.

18. The UE of claim 10, wherein the RA-RU information comprises one or two most significant bits (MSBs) indicating a first number of the sets of RUs for RA over the time domain, and remaining bits indicating a second number of contiguous RUs for RA in a frequency domain of the PPDU.

19. The UE of claim 18, wherein a non-initial set of RUs of the sets of RUs for RA is separated from preceding data by a short training field (STF) and a long training field (LTF).

20. The UE of claim 15, wherein:
a number of orthogonal frequency division multiplexing (OFDM) symbols for each set of RUs for RA is determined based on a length of the time domain of the PPDU and a number of STFs and LTFs for a non-initial set of RUs of the sets of RUs for RA; or
an initial set of RUs or a last set of RUs of the sets of RUs for RA in the time domain comprises more OFDM symbols than remaining sets of RUs of the sets of RUs for RA.
